(19) United States
(12) Patent Application Publication
(10) Pub. No.: US 2006/0171157 A1
(43) Pub. Date: Aug. 3, 2006

(54) Glowrims

(76) Inventor: Steve A. Karras, Verona, NJ (US)

Correspondence Address: SAK TECHNOLOGIES, INC., P. O. BOX 178, CEDAR GROVE, NJ, 07009, US

(21) Appl. No.: 10/953,651

(22) Filed: Jan. 31, 2005

(51) Int. Cl. F21V 33/00

(52) U.S. Cl. 362/500; 362/506

(57) ABSTRACT

An illumination device/system that is comprised of 2,4,6,or 8 leds per (customer requirements) that is rectangular that has electrical components and an steel mounting rod and is coated with a black coating material made of water based polymer compound. The illumination transmitting elements are hi fluxing leds that shine and illuminate at a 30-degree viewing angle and can be white, blue, green or red. The leds are powered by the vehicles battery 12 volts. The board is hermetically sealed in an black polymer material protecting the system from inclement weather. An observer from almost 50 yards away can view the system when illuminated at night and directed at the inner wheel/rim surface. The optical illumination system transmits light to the surface directed and is readily visible.

This invention relates to illumination arrangements for use as a safety or decorative lighting for automotive and any other motorized transportation systems that are directed toward the wheel/rim surface for reflection and illumination.

There are many needs for illumination system in the field of safety and automotive decorative customizing. However, typically unique devices have been devised for each application. For example, roadside warnings devices or warning beacons coupled to automotive systems for providing illumination for emergency or roadside warning and safety purposes.

The primary configured arrangement is provided for automotive entertainment and for the auto enthusiast. Mostly, however, the illumination device is to enhance the enthusiast automotive wheels and surfaces of the shinny or non-shinny surface of Wheels and Rims. The illumination system will light the area it is directed towards. Blacken areas in the Wheel well or undercarriage of the Wheel and Rim area will be enhanced by the illumination system.

No other system or lighting configuration allows the lighting of the back area of a Rim or Wheel area. The direct illumination systems will light up the entire surface area it is directed towards on a Wheel or Rim.

Further, no other objects can be used in this fashion. This illumination system is designed to be lightweight and easily mountable to any automotive steering or drive train system. The system is has a SPST (Single Pole Single Throw) switch that is mounted and controlled from the cockpit of the vehicle.

No other lighting system is available to the Automotive Commercial Market that will produce this type of effect. A versatile lighting system such as this is that is useful in several different ways can be used on any vehicle that has an automotive battery system. The present invention is directed to provide lighting to wheels and rims that no other attempt has been made. This single system also provides versatile resolves keeping a wide variety of applications buy simplify directing the light system to the users preference.

Some commercially available devices are not readily adaptable for many different possible needs, creating a void even though some such devices are at hand such a neon lights. Since the LED system provides 4 different types of focused beams of light. From the 2 light system up to the 8 light system. The LED base product life span is mush longer than the standard neon bulb system.

An illumination device according to an aspect of the present invention comprises of a source and a number of high illumination high fluxing LEDS that use a 30 degree viewing angle. These LEDS are attached to a Printed Circuit Board that have these lights separated to light an 8-10 inch surface area approximately 12 inches away. An electrical circuit regulates the voltage going to the lights on the printed circuit board.

Since the system is small and light weigh it can be mounted under any vehicle and placed out of sight and out of the way of any moving parts of the vehicle. The light by radiating outwardly from the printed circuit board provides broad radiation as comprised focused in beams. This kind of system is readily seen at night from many different directions and by providing a source of light of a given color and intensity it can be used for safety as well as decorative or mood purpose.

In one aspect, the system is arranged to be hermetically sealed with a polymer sealant system. This system encapsulated the electrical components and wires to prevent water/whether damage. The wires and electrical components can are Surface mount and Plated Through Hole. The Printed Circuit is made of Glass E FR4 material. The entire system is mounted with a Steel Rod 0.090 inches in diameter/18 inches long and mounted in the center of the hole. 1-quarter inch from the end of the rod it is manually bent to a 90-degree angle. Once bent it is mounted using solder wire Sn/Pb 63/37 and secured with a 2-part BiPax 2112 epoxy.

In a further aspect the device includes attachment means for attaching the system to an object and preferably, the attachment means is at least two tie wraps (12 inches long) per system/steel rod.

### IN THE DRAWING Note: Figure Drawing is Paged Marked 1 through 10

FIG. 1 is electrical schematic, which shows several circuits that can be used as 1, 2, 3 or 4 different light configurations that could us 2 Leds, 4 Leds, 6 Leds and 8 Leds. This Schematic allows making 4 different product lines 2 thru 8 light systems.

FIG. 2 identifies the mounting and the specified top view of system. This system has an 18″ steel 0.90″ thick rod soldered to it and epoxies. FIG. 2 also shows the layout of the leds and the components.

FIG. 3 shows a side view A with the wires that are used and the rod soldered and epoxies areas. Also, side view B shows the position of the leds.

FIG. 5 shows the number1. The T13/4 Super Flux LEDS, number2. 0805 surface mount resistor 60 ohm±5%, number3. Small Outline Integrated Circuit 8 Bridge rectifier. number4. 18″ 19 strand Teflon wire Black and Red. and number5. 0.062 glassE FR4 printed circuit board. FIG. 6 is a coating compound made of acrylic that will protect the entire system from weather damage.

FIG. 6 is the solder mask system for the FIG. 5

FIG. 7 is the drill chart for the plated and non-plated holes of FIG. 5

FIG. 8 is the silkscreen artwork for designated the locations and numbering of FIG. 5.

FIG. 9 is the bottom solder mask for FIG. 5.

FIG. 10 is the layer 2 artwork for trace solder side bottom for FIG. 5.

FIG. 11 is the layer 1 artwork for trace component side top for FIG. 5.

FIG. 12 shows the system being attached to a vehicles undercarriage and being attached to the front FIG. 12/a and to the back FIG. 12/b. Several other locations can be used and developed as locations.

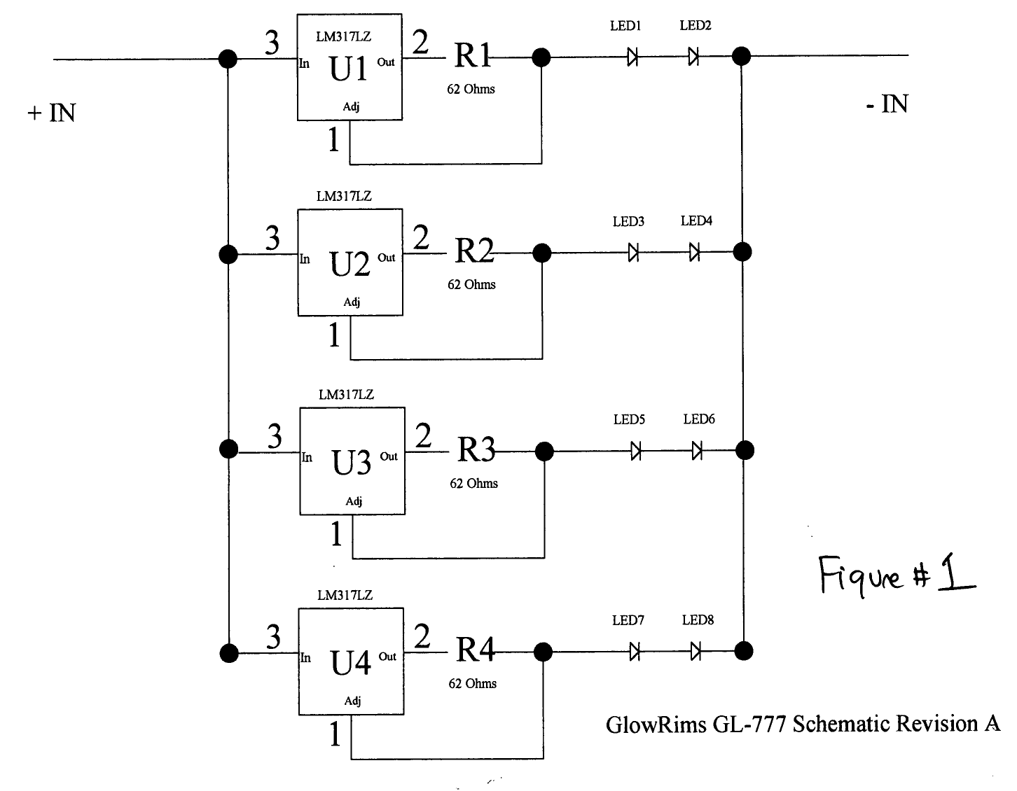

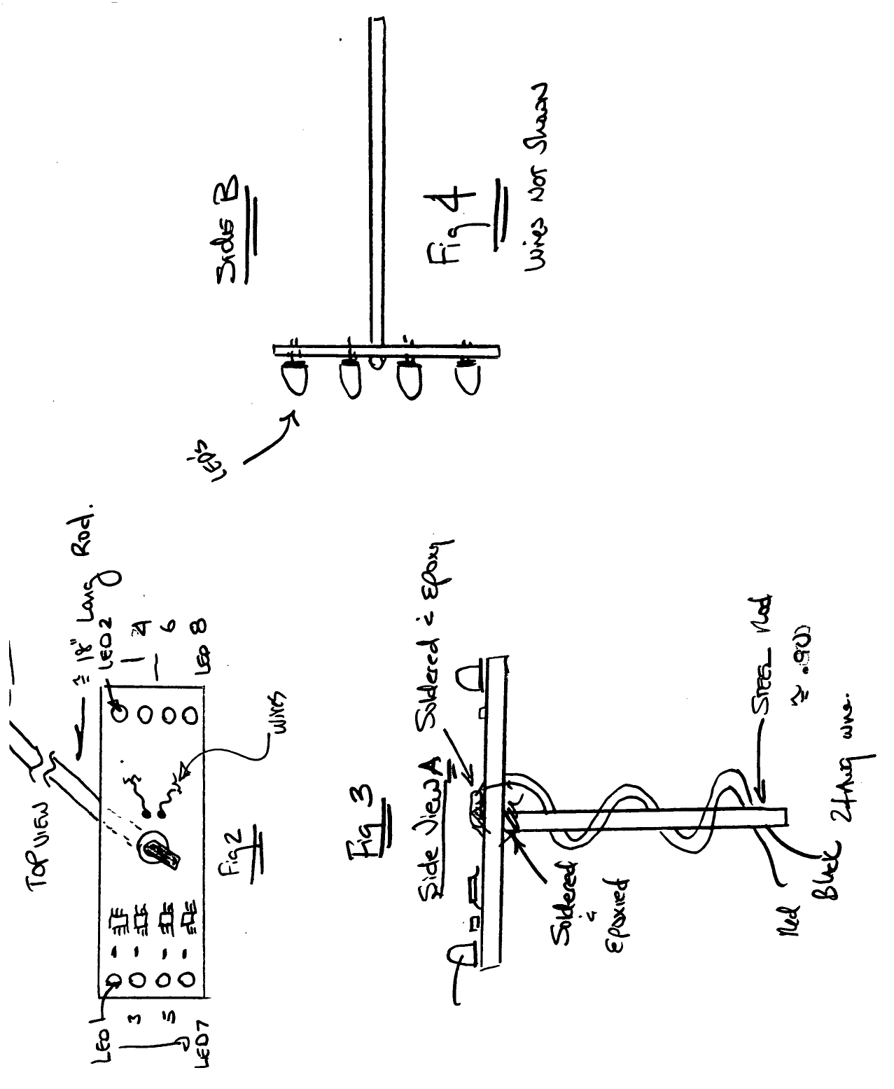

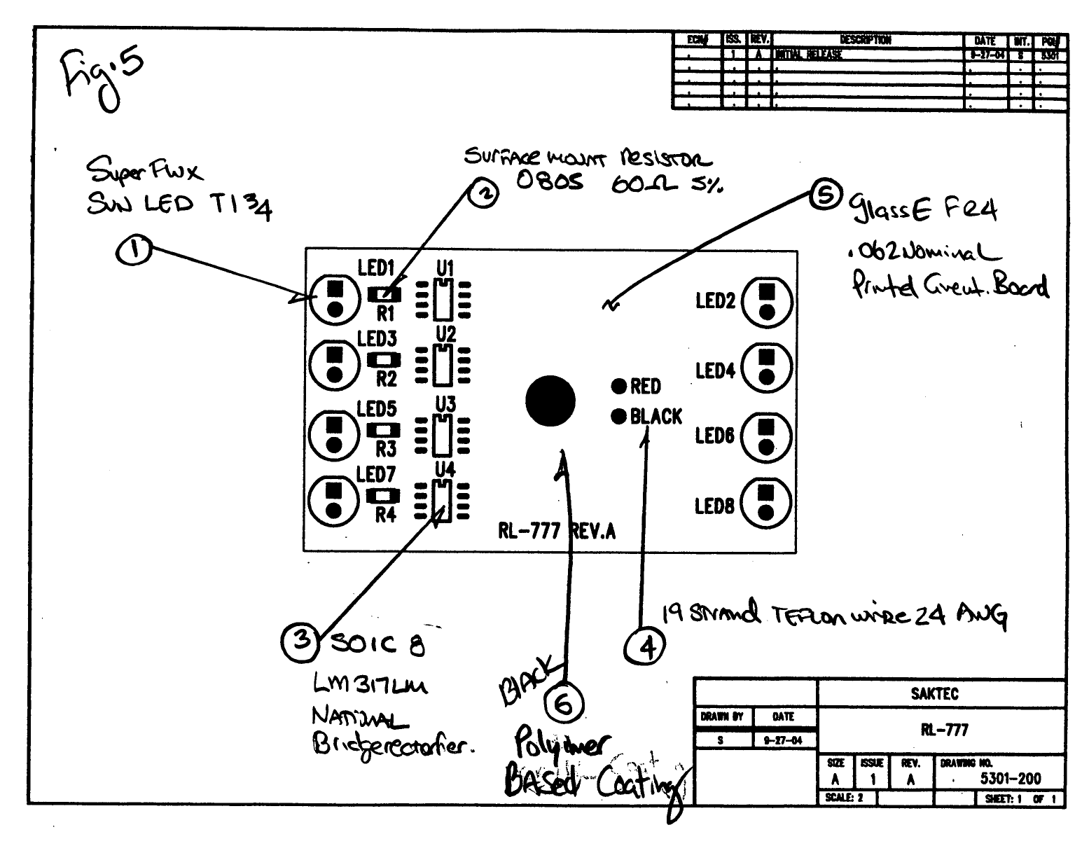

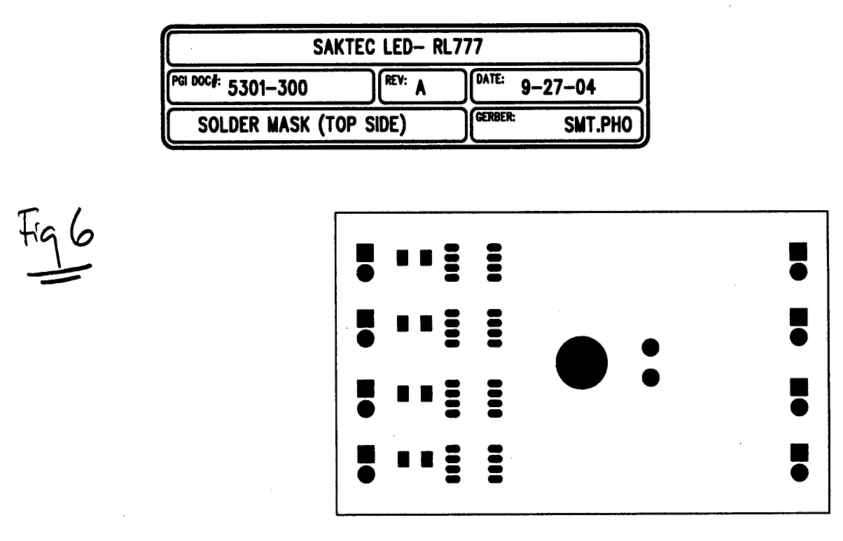

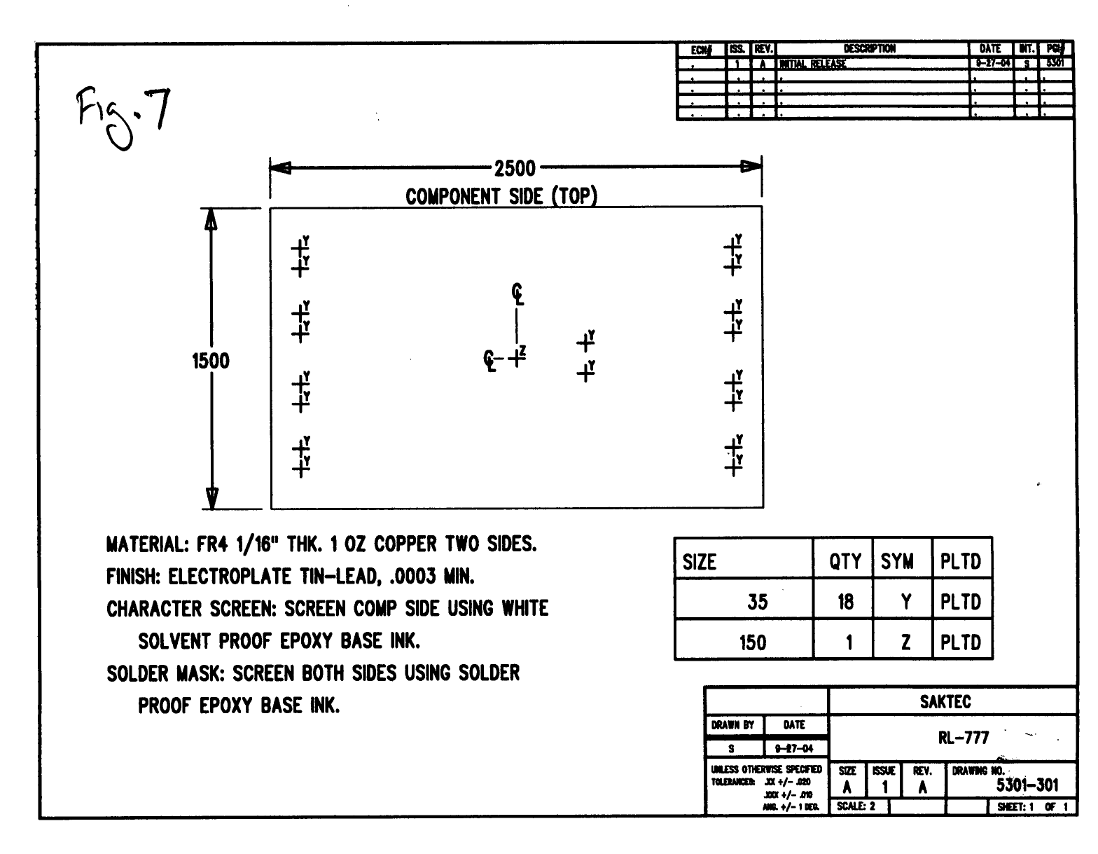

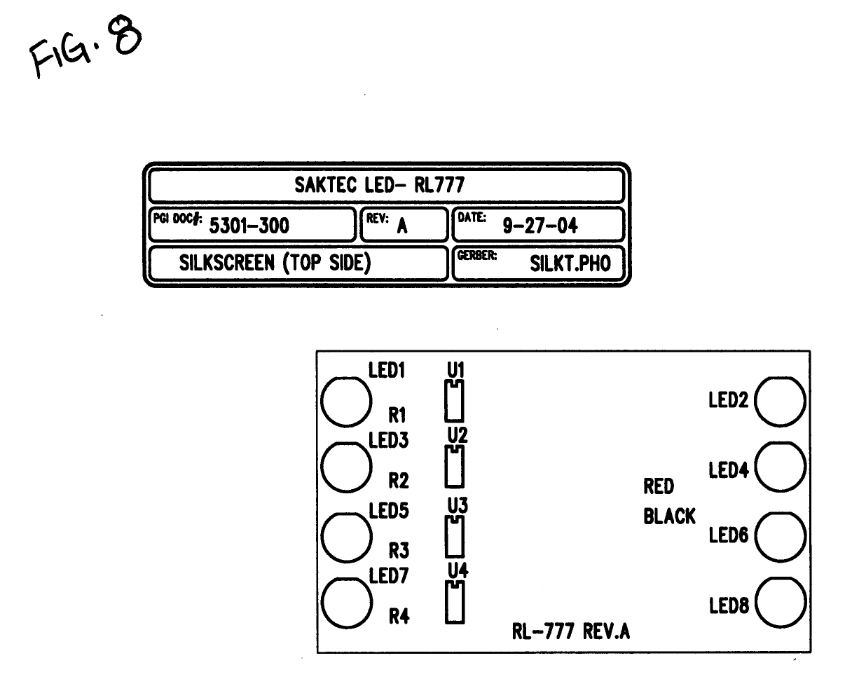

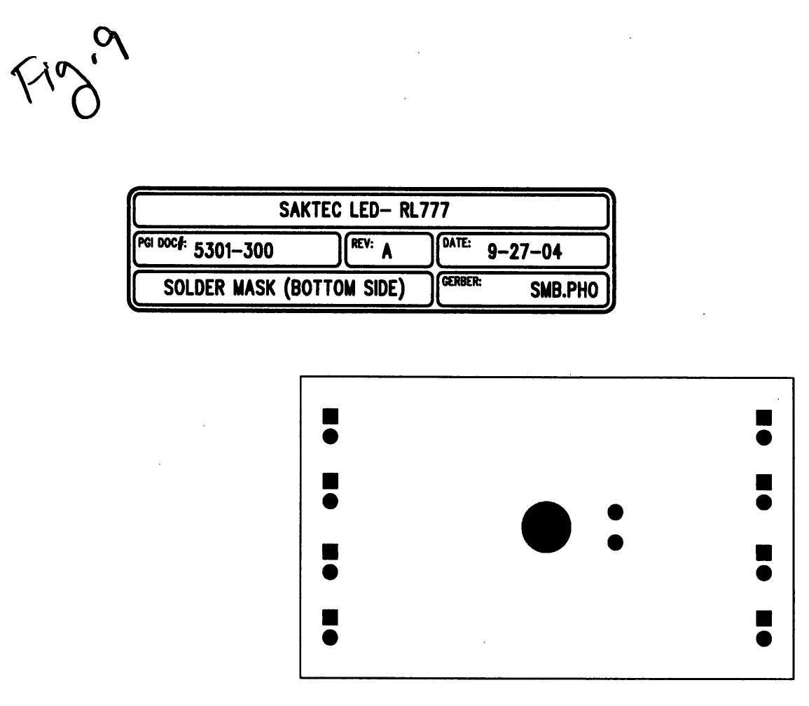

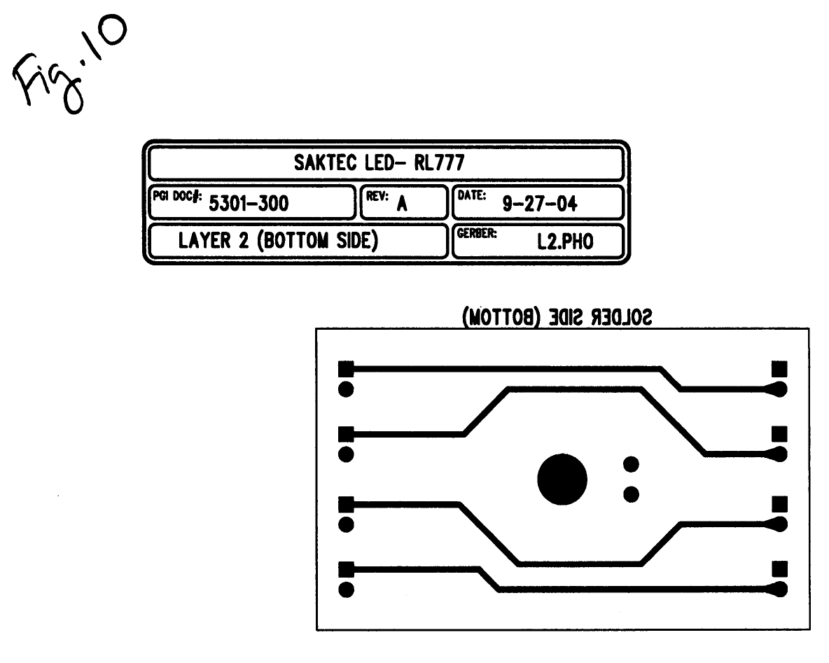

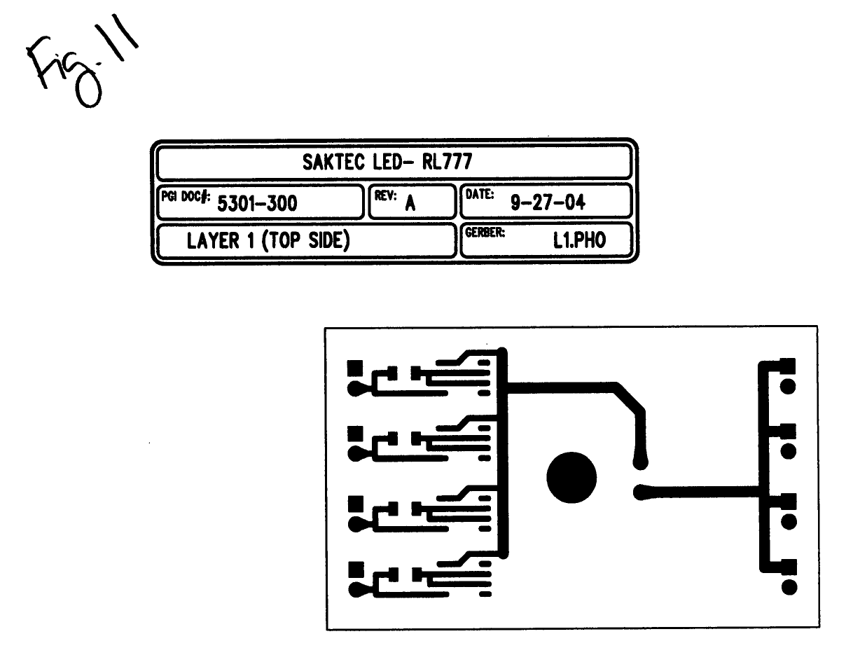

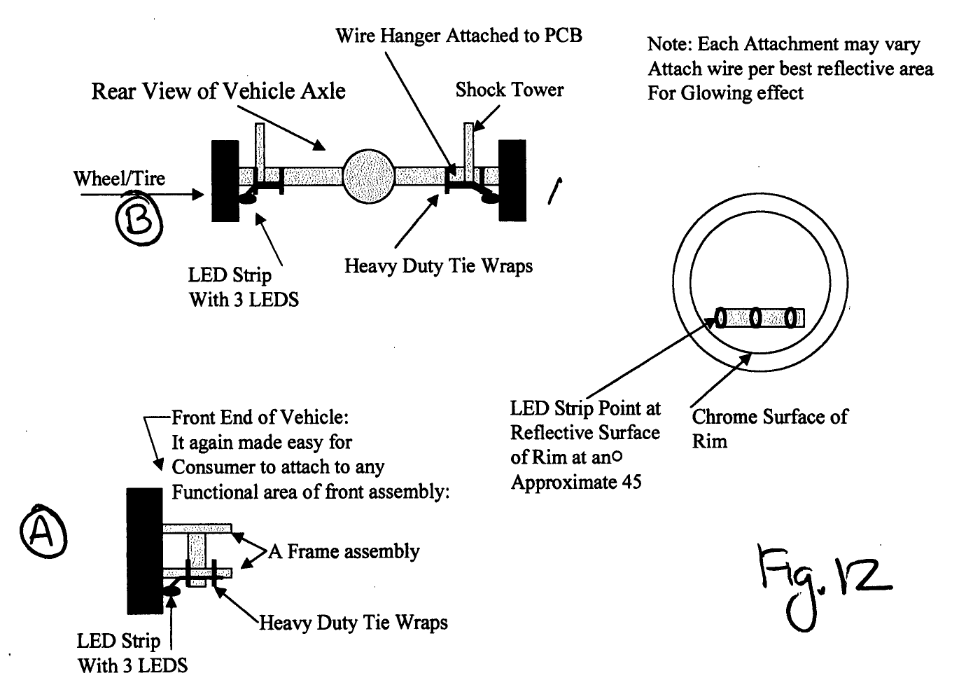

What is claimed is:

1. An illumination device comprising: a source of illumination; a selective array of leds that transmit a beam of light have a combined peripheral surface along an area between a mounted location directed at a reflective surface or non-reflective surface. Optical transmitting diodes (leds) that have a mounted device, which is secured, and can withstand automotive environment that is mounted under an automotive chassis. This is illuminated with 12 volts power supply and mounted using cable ties/zip ties. Coated and potted in polymer based coating which withstands harsh environmental conditions.

2. The device of claim 1 wherein said light array is arranged for providing enhanced illumination behind vehicle wheels and rims and wheel wells.

3. The devise of claim 2 wherein the array is white, purple, blue, green and red.

4. The device of claim 1 wherein the array is mounted with a flexible adjustable rod that is in 18 inch lengths that can be configured to desired length.

5. The device in claim 1 is protected with a polymer coating sealant system.

6. The device in claim 1 can be powered by 12 volt battery.

7. The device in claim 1 is secured using an 18″ inch rod that is secured to printed circuit board.

8. The device in claim 1 can put out approximately the illumination of a 1.5 watt bulb.
